(19) United States
(12) Patent Application Publication
(10) Pub. No.: US 2007/0238068 A1
(43) Pub. Date: Oct. 11, 2007

(54) Self-limiting depth gauge spherical dental burr and method of use

(76) Inventor: Isaac Comfortes, Santa Monica, CA (US)

Correspondence Address: Lewis B. Sternfels, 3100 Inglewood Boulevard, Los Angeles, CA, 90066-1062, US

(21) Appl. No.: 11/784,530

(22) Filed: Apr. 6, 2007

Related U.S. Application Data
(60) Provisional application No. 60/790,768, filed on Apr. 6, 2006.

(51) Int. Cl. A61C 3/02

(52) U.S. Cl. 433/165

(57) ABSTRACT

A burr (30) includes a spherical cutting element (36) and a shield (40) integrally placed behind the burr. The shield is circularly configured, has a rounded periphery and is provided with a smooth tooth-engaging surface. The shield thus insures that the depth of the penetration—into the tooth is precise, as predetermined, without inflicting deleterious harm to the tooth. The present invention further relates to a method, utilizing the shield, for precise tooth preparation of porcelain veneers and porcelain crowns.

### CROSS-REFERENCE TO RELATED APPLICATION

This application claims the benefit of U.S. Provisional Application No. 60/790,768, filed 06 Apr. 2006.

### REFERENCE REGARDING FEDERAL SPONSORSHIP

Not Applicable

### REFERENCE TO MICROFICHE APPENDIX

Not Applicable

1. Field of the Invention

The present invention relates to a burr having a self-limiting depth gauge and an abrasive spherical cutting element for precise depth penetration of a dental surface and for providing the space necessary to accommodate the required thickness of porcelain restoration, in which the self-limiting depth gauge encompasses a smooth shield at the base of the abrasive spherical cutting element to insure the desired depth of the penetration without deleterious harm to the tooth. The present invention further relates to a method utilizing the shield for enhanced preparation of the tooth for placement thereon of porcelain veneers and porcelain crowns.

2. Description of Related Art and Other Considerations

In restorative dentistry, successful crown and bridge work begins with precise tooth reduction. Whether a tooth is to receive a crown or a veneer, inadequate tooth preparation will place limitations on the dental technician. One limitation is the inability to establish a physiologically contoured restoration which could result in periodontal problems, such as gum recession or disease, or in a less than aesthetically pleasing appearance which, in turn, creates an unhappy patient-doctor relationship. Another concern is that dental laboratories complain that there is insufficient tooth reduction for crown and bridge restorative procedures which also cause tension in dentist-laboratory relationships. These matters are seen as problematical and not necessarily appreciated by all concerned. The above-mentioned situation is a result of dentists not using any type of depth gauge when preparing teeth for crowns or veneers; such work is performed purely visually. While it may be proposed that the removal of more tooth structure than what is normally indicated is a correctable problem to fabricate the necessary restoration, this is not an acceptable solution; over reduction creates the major potential of a high risk of tooth nerve damage.

Although there exist dental burrs that provide for a depth reduction, e.g., U.S. Pat. Nos. 7,021,933, 4,526,542 and 6,511,322, the burrs disclosed in these patents have a flat sharp edge, which configuration does not lend itself to a long lasting cutting edge. With a diamond coated burr, for example with an angled edge, such as at a 90° edge, plucking of the diamond particles occurs. This plucking dulls the burr and consequently generates heat at the working site, which may require special cooling to prevent undesirable heating of the nerve. If the tooth surface to be reduced is approached at a slightly oblique angle with respect to the burr, the sharp edge may engage and cause deflection of the burr from the penetration site. This may result in damage to adjacent structures.

Regarding U.S. Pat. No. 7,021,933, the inability to seat the burr with a flange for teeth with steeply sloped cusps on posterior teeth is of minor concern because such tooth morphology is found on young individuals who rarely require a crown procedure. Laceration of gingival tissues is easily avoided since depth reduction guidance is rarely needed at the tooth-tissue junction. The inability to maintain the self-limiting burr with a shield at the required depth as it is moved along the patient's convoluted surface generating grooves at even depths is not an issue because straight depth penetrations are fabricated with the present inventive method. In U.S. Pat. No. 7,021,933, visibility of the abrasive end of the burr is critical. The shank of the burr is placed perpendicular to the tooth surface and held in that position during depth penetration.

Kometas U.S. Pat. No. 6,511,322 states that having a disc shaped drill shield, which is attached to a drill, prevents cooling air/water spray from reaching the tooth surface being reduced and, consequently, could create nerve damage. First, if insufficient air/water spray is not reaching the area being reduced, a water syringe can easily be employed to eliminate the problem. Second, dental students usually prepare most restorations in dental school without water spray and, by doing so, do not create more nerve damage than in private practice. Third, the self-limiting gauge burr technique requires minimal contact time with the tooth, thereby reducing the risk of nerve damage.

### SUMMARY OF THE INVENTION

These and other problems and/or considerations are successfully addressed and overcome by the present invention, by utilizing a burr having a spherical cutting element and the placement of a shield integrally onto the burr, and behind the spherical cutting element. The shield is circularly configured, has a rounded periphery and is provided with a smooth tooth-engaging surface at the base of the spherical cutting element. The shield thus insures that the depth of the penetration into the tooth is precise, as predetermined, without causing any other problem to the tooth. The present invention further relates to a method utilizing the shield for precise tooth preparations for later placement of porcelain veneers and porcelain crowns on the prepared teeth.

Several advantages are derived from this arrangement. One object of the present invention is to provide a precise depth cutting instrument, that is, a self-limiting depth gauge burr which is limited to the precise penetration of the tooth structure. A smooth shield at the base of the spherical cutting element limits the depth of the penetration. The spherical cutting element is amenable to manufacture with different diameters. As distinguished from a non-spherical diamond coated cutting element, for example, the plucking of the diamond particles using the spherical round diamond coated element of the present invention occurs at lower rate thereby providing longer lasting cutting efficiency and reduced heat to the tooth. Control of the burr is enhanced and made more favorable utilizing the rounded surface than a sharp edge because of the reduced probability of deflection. A further advantage is to provide a self-limiting depth gauge burr with different diameters that can be utilized with any dental procedure where control of depth in tooth reduction is critical. Still another advantage is to provide a method of preparing a tooth for porcelain veneer or porcelain crown. Holes are made in the tooth to the precise depth and the remaining tooth structure is ground away achieving a reduction to that predetermined depth. Another advantage is generally to make tooth preparation easier and faster.

Other aims and advantages, as well as a more complete understanding of the present invention, will appear from the following explanation of exemplary embodiments and the accompanying drawings thereof.

### BRIEF DESCRIPTION OF THE DRAWINGS

FIG. 1 is a perspective view of a self-limiting depth gauge spherical dental burr configured in accordance with the teachings of the present invention;

FIG. 2 is a side view of the burr depicted in FIG. 1;

FIG. 3 is an end view of the burr depicted in FIG. 2 taken along line 3-3 thereof;

FIGS. 4-6 are side views, similar to that shown in FIG. 2 illustrating typical sizes of the inventive spherical burr whose respective diameters are 0.5 mm, 1.0 mm and 1.2 mm for forming tooth depth drillings of the same dimensions that are the most utilized depths;

FIGS. 7-16 illustrate a porcelain veneer technique on an anterior (front) tooth utilizing the present invention, in which FIG. 7 shows a penetration of 0.5 mm of the tooth as shown in profile, FIG. 8 is an example of multiple hole depth penetrations of the tooth as sown in frontal view, FIG. 9 depicts in tooth profile the use of a cylindrical, rounded end diamond burr to reduce the remaining tooth structure to 0.5 mm, FIG. 10 illustrates in tooth profile the completed tooth preparation showing what was removed and what the porcelain veneer will restore, and in which FIGS. 11-16 illustrate an incisal view of teeth being prepared for the placement of a porcelain veneer thereon;

FIGS. 17-20 illustrate a technique for preparing a porcelain crown on an anterior (front) tooth in which FIG. 17 depicts a penetration of usually 1.0 mm, FIG. 18 shows a remaining tooth reduction where the tip of the tooth is reduced by 1.2 mm, FIG. 19 is a profile view of the preparation of the crown, and FIG. 20 is a frontal view of the crown preparation;

FIG. 21-23 Illustrate a veneer tooth preparation on a premolar or posterior (back tooth) of a typical half millimeter depth; and

FIG. 24-26 Illustrate a porcelain crown tooth preparation on a premolar where the biting surface is reduced by 1.2 mm and the remainder of the tooth is reduced by 1.0 mm.

### DETAILED DESCRIPTION

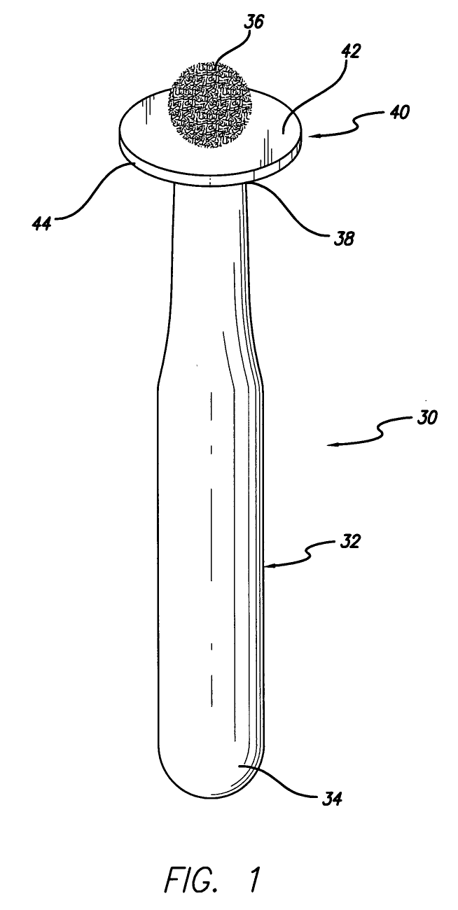

Accordingly, with reference to FIGS. 1-3, a self-limiting depth gauge spherical dental burr 30 comprises a shank 32 which is adapted to be held at one end 34 by the bit of a drilling machine of conventional construction. A spherical cutting element 36 of diamond, carbide or other useful drilling material is secured to the shank at its opposite end 38 by any conventional means. A shield 40, acting as a self-limiting depth gauge, is integrally secured to the shank, and directly behind the burr. shield 40 is essentially flat, having a smooth surface 42 which is designed to contact the enamel without harming it or, if the enamel is missing, onto the remaining tooth surface. shield 40 is terminated at its periphery with a rounded or curved surface to avoid any sharp corner.

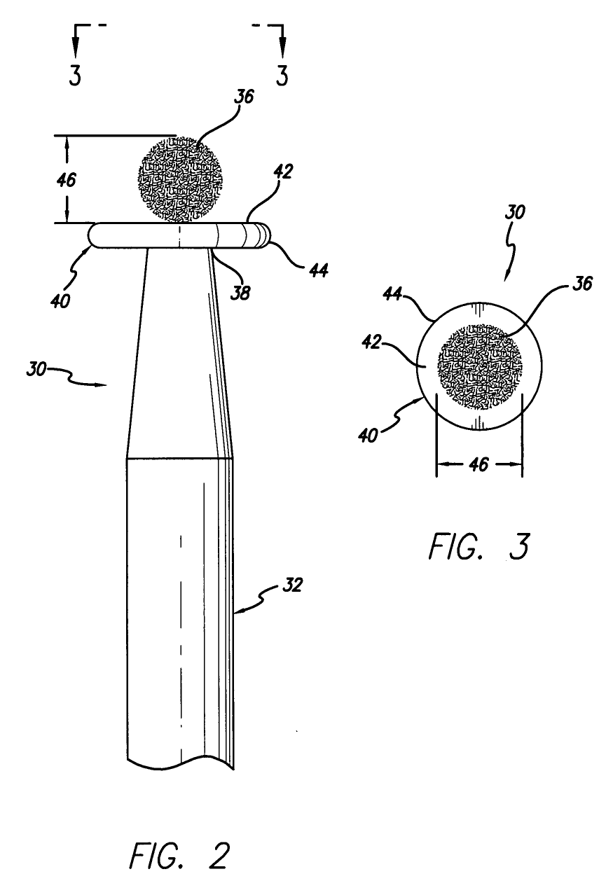

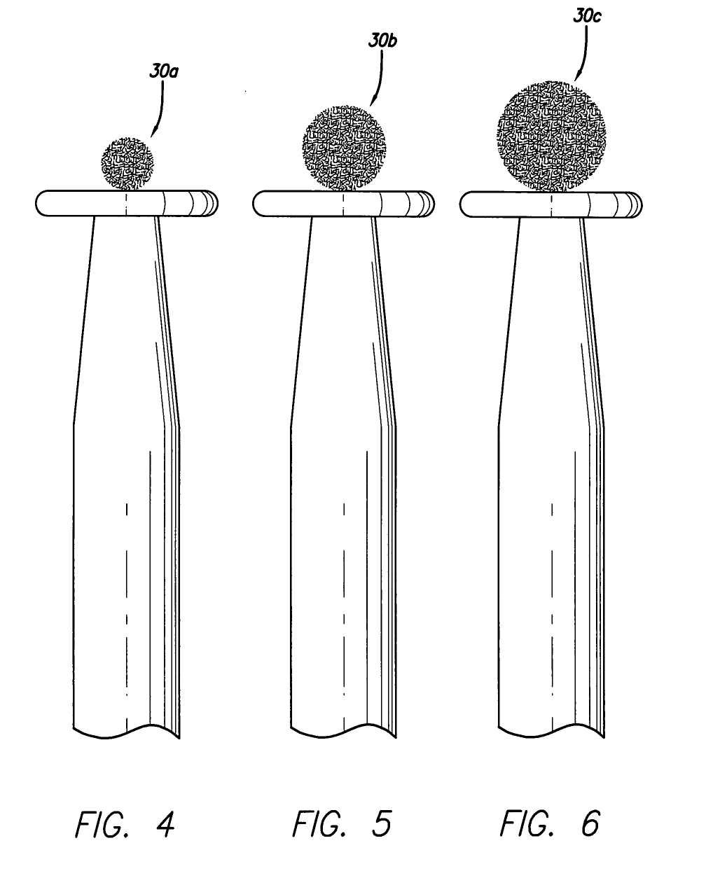

Spherical cutting element 36 has a specified diameter 46 (e.g., see FIGS. 2 and 3) which determines its cutting depth, as enforced by shield 40. The burr may be manufactured with a variety of diameters, such as depicted in FIGS. 4-6, the most utilized being those of 0.5 mm, 1.0 mm and 1.2 mm to provide cutting depths of those dimensions.

Accordingly, burrs with differently sized spherical cutting elements are used to establish a predetermined maximum depth for creating a depression. This avoids any undesirable grinding into the tooth and possibly completely through the enamel or further, if desired, into the dentin. Alternately stated, the depth of tooth removal is restricted, when the tooth is prepared for placement of a crown, usually over the dentin, or of a veneer over whatever tooth surface that may exist. Thus, tooth reduction is made more predictable and prevents excessive or inadequate removal of the tooth structure, and avoids guess-work.

In practice, the dentist marks dots on the tooth where work is to be performed. Then, the burr with its integral shield is applied to form precisely the penetrations. The size of the burr is tailored to the specific procedure desired and, therefore, a host of different diameter burrs with their integral, self-contained, depth-limiting shields are made available. As examples, for preparation for crown placements, the burr typically ranges from 1 mm to 1.5 mm in diameter and for veneer work, the burr typically ranges from 0.3 to 0.6 mm in diameter.

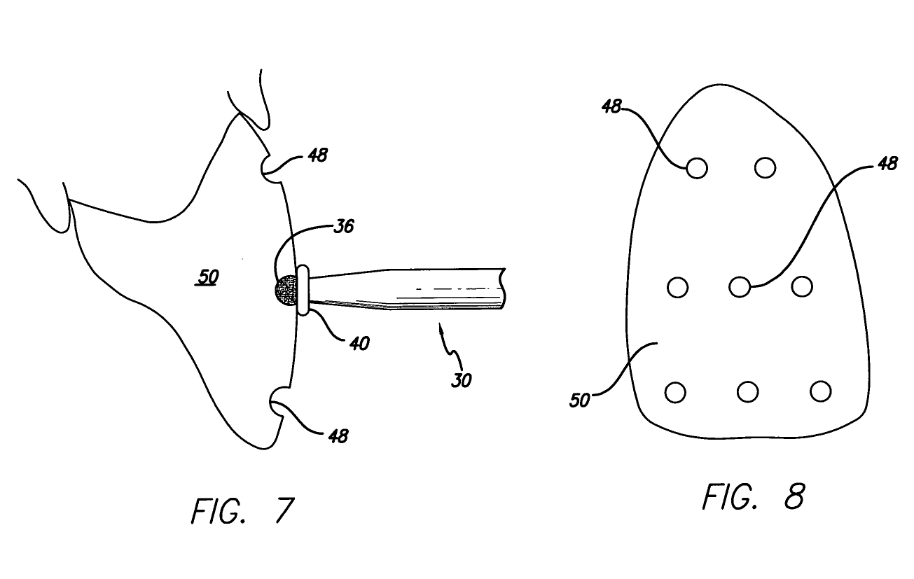

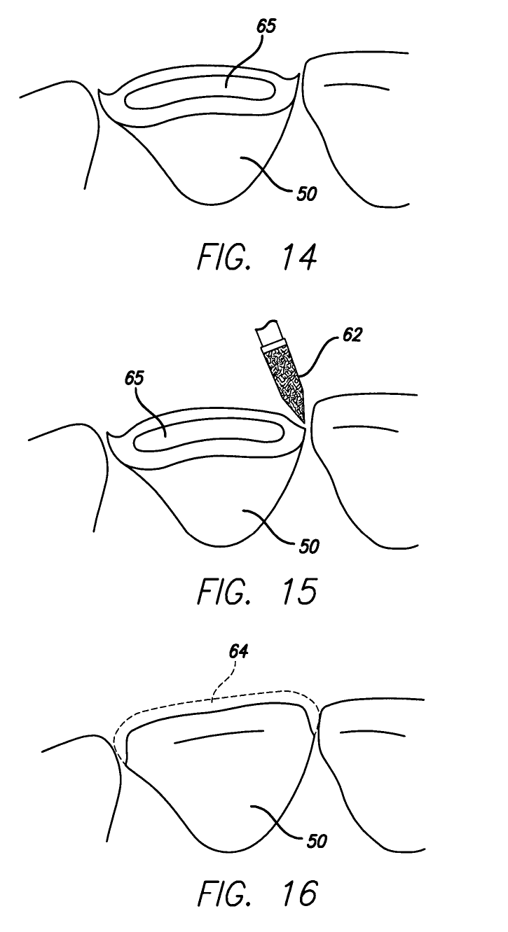

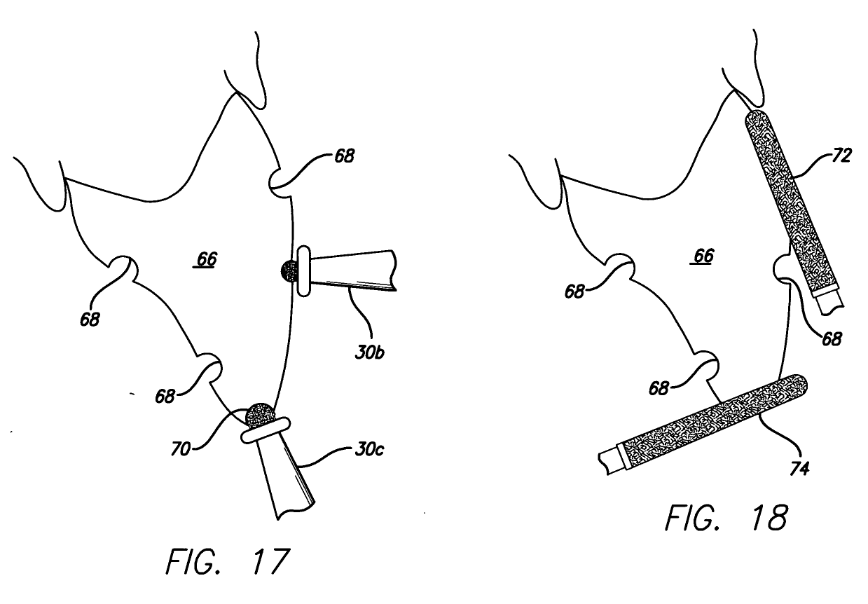

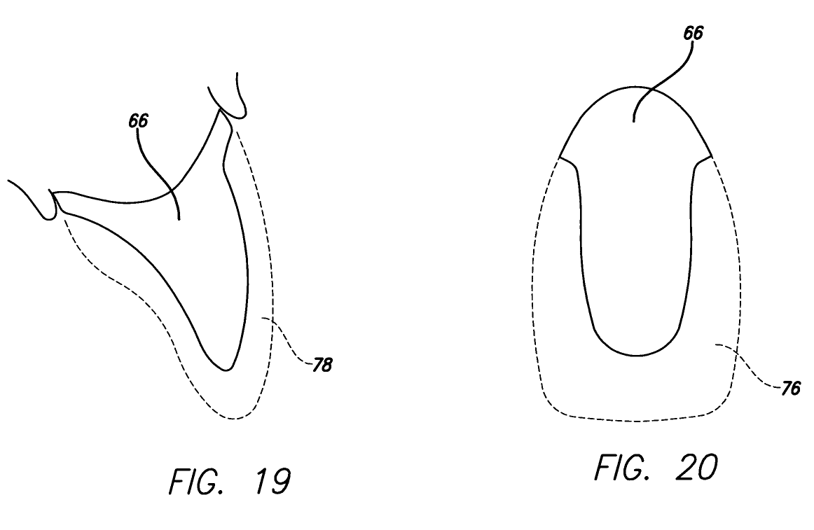

FIGS. 7-16 illustrate a porcelain veneer technique while FIGS. 17-20 illustrate a technique for preparing a porcelain crown, which techniques are both utilized for anterior (front) teeth.

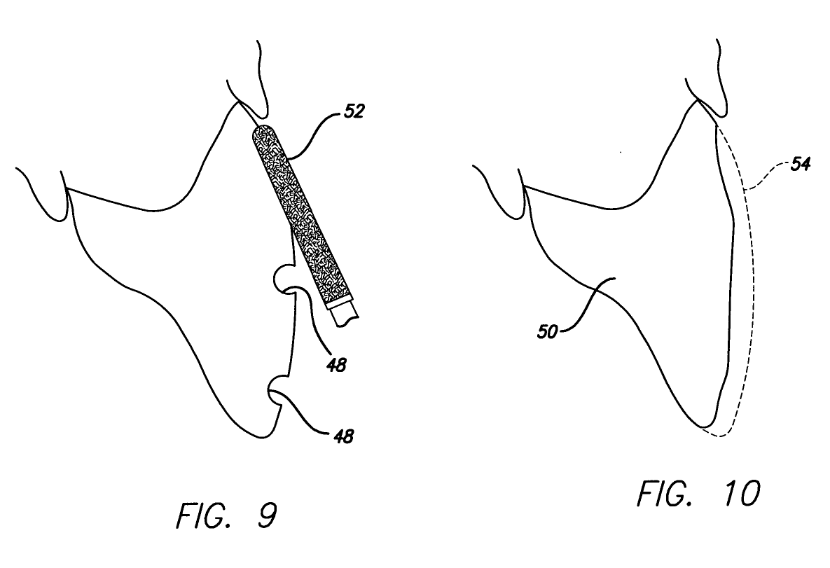

Referring to FIGS. 7-16, in FIG. 7, penetrations 48 of 0.5 mm depths are made into an anterior tooth 50 by a drill formed with a burr 30a (also see FIG. 4), with FIG. 8 depicting a multiple of such hole depth drillings 48. A cylindrical, rounded end diamond burr 52 (FIG. 9) is used to reduce the remaining tooth structure, as existing between penetrations 48, to 0.5 mm by using these penetrations as reference markers. FIG. 10 illustrates the thus prepared tooth showing what was removed by burr 52, where the removed tooth material is denoted therein by dashed line 54.

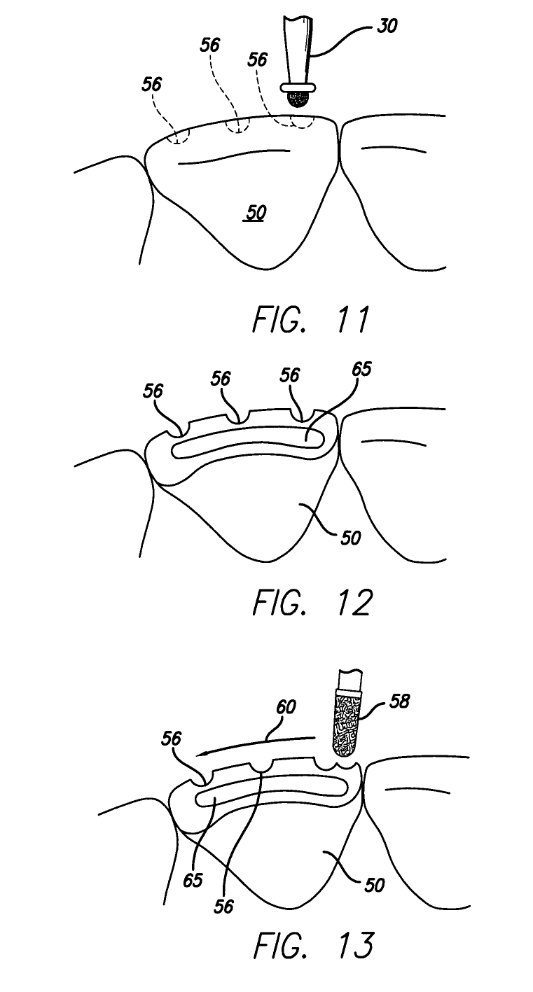

FIGS. 11-16 illustrate an incisal view of teeth being prepared for the placement of a porcelain veneer thereon. Here, in tooth 50, a spherical burr 30a forms penetrations 56 (FIGS. 11 and 12), which form reference points for further tooth removal as depicted in FIG. 13 by a burr 58 which is moved in the direction of arrow-headed line 60. Further preparation proceeds (FIGS. 14-16), utilizing a cylindrically shaped burr 62 having a pointed end, which procedure terminates (FIG. 16) in a tooth having removed material as denoted therein by dashed line 64. In FIGS. 12-15, the dentin is identified by indicium 65.

Referring to FIGS. 17-20 which illustrate a technique for preparing a porcelain crown on tooth 66, a spherical burr 30 forms penetrations 68 and 70 (FIG. 17), which form reference points for further tooth removal as depicted in FIG. 18 by burrs 72 and 74, leaving a tooth showing removed material as denoted therein by dashed lines 76 and 78.

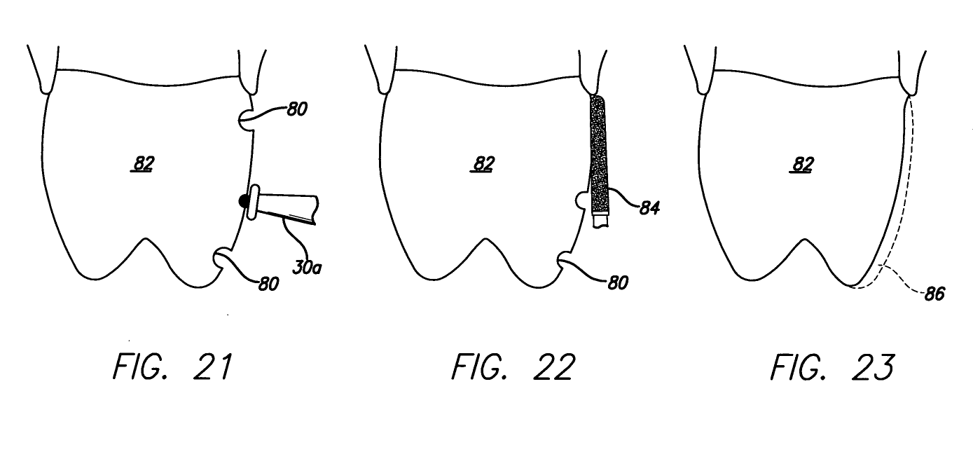

Reference is now made to FIG. 21-23 which illustrate a veneer tooth preparation on a premolar or posterior (back tooth) of a typical half millimeter depth. In FIG. 21, a burr 30a, such as that depicted in FIG. 4, forms penetrations 80 in a tooth 82 which, in the same manner as previously described, form reference points for further removal of tooth material by a cylindrical, rounded end diamond burr 84, thus leaving a product having removed material as denoted by dashed line 86.

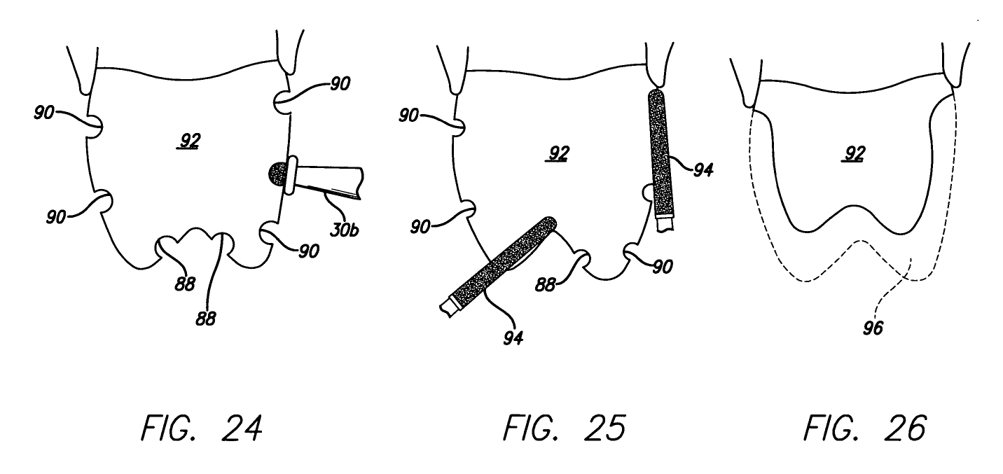

In FIG. 24-26 which illustrate a porcelain crown tooth preparation on a premolar for reducing the biting surface by 1.2 mm and the remainder of the tooth by 1.0 mm, burrs 30c and 30b, respectively, such as that depicted in FIGS. 6 and 5, form penetrations 88 and 90 in a tooth 92. Cylindrical, rounded end diamond burrs 92 and 94 respectively reduce the remaining tooth portions between the precisely cut holes to the tooth, as shown in FIG. 26, with reduced surfaces as referred to by dashed line 96.

Although the invention has been described with respect to particular embodiments thereof, it should be realized that various changes and modifications may be made therein without departing from the spirit and scope of the invention.

What is claimed is:

1. A dental burr comprising a spherical cutting element having a specified diameter and a self-contained, depth-limiting shield secured adjacent to said spherical cutting element which shield is adapted to contact the tooth and thus to limit the depth of drilling of said spherical cutting element into the tooth.

2. A burr according to claim 1 in which said shield includes a smooth surface adjacent to said spherical cutting element for minimizing harm to the tooth during drilling use of said cutting element.

3. A burr according to claim 2 in which said shield comprises a generally flat circular configuration having a curved peripheral surface.

4. A burr according to claim 1 in which said shield comprises a generally flat circular configuration having a curved peripheral surface.

5. A burr according to claim 4 in which said shield includes a smooth surface adjacent to said spherical cutting element for minimizing harm to the tooth during drilling use of said cutting element.

6. A method for preparing a tooth for a porcelain crown and a porcelain veneer thereon comprising the steps of:
utilizing a dental burr having a spherical cutting element of specified diameter and an integral self-contained, depth-limiting tooth-insertion shield positioned adjacent to said spherical cutting element for limiting the depth of drilling into a tooth;
severally penetrating the tooth by the dental burr to a specified depth as dictated by the specified diameter of the spherical cutting element and limited by said shield for forming a plurality of penetrations;
using the penetrations as depth guides, grinding portions of the tooth between the penetrations by a cylindrical, rounded end diamond burr to reduce the remaining tooth structure to the specified depth.
